(19) United States
(12) Patent Application Publication
(10) Pub. No.: US 2026/0267831 A1
(43) Pub. Date: Sep. 10, 2026

(54) ANALYSIS OF PROCEDURAL STRUCTURED QUERY LANGUAGE (SQL) CODES

(71) Applicant: Infosys Limited, Bangalore (IN)

(72) Inventors: Rajesh Balakrishnan, Bengaluru (IN); Krishnamurty Sai Deepak, Bengaluru (IN); Sweta Gupta Bansal, Bengaluru (IN); Amrita Chatterjee, Bengaluru (IN); Vinay K., Bengaluru (IN)

(73) Assignee: Infosys Limited, Bangalore, KA (IN)

(21) Appl. No.: 19/084,897

(22) Filed: Mar. 20, 2025

(30) Foreign Application Priority Data
Mar. 4, 2025 (IN) 202541018927

(51) Int. Cl. G06F 16/21; G06F 8/41; G06F 16/242

(52) U.S. Cl. CPC G06F 16/214; G06F 8/427; G06F 8/433; G06F 16/2433

(57) ABSTRACT

Analysis of procedural structured query language (SQL) codes is provided. A procedural SQL code block, comprising various code elements, is parsed, and a parse tree is generated. The parse tree includes nodes for each code element. A node may represent a code token. In the parse tree, directed edges are generated that define a dependency between the code elements such that each directed edge couples two nodes associated with two different code elements. Contexts are then generated for some code elements, a context indicating a purpose of a code element in the code block. The code block is split into chunks based on the parse tree with the directed edges. Each chunk includes a subset of the code block and contexts of code elements present in the corresponding subset of the code block. The chunks are then processed to generate an output associated with the code block.

### FIELD OF THE DISCLOSURE

Various embodiments of the present disclosure relate generally to code analysis. More specifically, various embodiments of the present disclosure relate to the analysis of procedural structured query language (SQL) codes.

### BACKGROUND

Procedural structured query language (SQL) was extensively used for developing legacy applications. The technological developments in the field of computer science, however, have shifted the balance towards modern programming languages (e.g., object-oriented programming language) for better security, code reusability, and modularity. This has resulted in organizations, that heavily rely on procedural SQL, having to migrate to modern programming languages. Directly migrating legacy applications to modern programming languages is complicated due to the fundamental differences between procedural and object-oriented paradigms. As a result, a two-step migration process is required. Firstly, the current procedural SQL code may be analyzed to determine the underlying business rules. Further, a new application is engineered in accordance with modern programming languages using the determined business rules.

The analysis of the procedural SQL code is typically human-driven. The procedural SQL codes may be large (e.g., spanning about two million tokens). Additionally, these codes often lack adequate documentation, creating significant challenges in their analysis. As a result, manual code analysis may be time-consuming, resource-intensive, and often error-prone. Further, the manual execution of the migration process requires expertise in both procedural SQL and modern programming languages, and the absence of any one of the two makes the process laden with errors and inconsistencies, ultimately rendering the migration inefficient and challenging.

In light of the foregoing, there exists a need for a technical and reliable solution that overcomes the abovementioned problems.

Limitations and disadvantages of conventional and traditional approaches will become apparent to one of skill in the art, through the comparison of described systems with some aspects of the present disclosure, as set forth in the remainder of the present disclosure and with reference to the drawings.

### SUMMARY

Methods and systems for analysis of procedural structured query language (SQL) codes are provided substantially as shown in, and described in connection with, at least one of the figures.

In an embodiment of the present disclosure, a system comprising processing circuitry is disclosed. The processing circuitry is configured to parse a code block comprising a plurality of code elements. Each code element corresponds to one of a code block name, a parameter, a variable, a statement, or a condition. The processing circuitry is further configured to generate, based on the parsing of the code block, a parse tree. The parse tree comprises a plurality of nodes for each code element of the plurality of code elements, with each node representing a token of the corresponding code element. The processing circuitry is further configured to generate, in the parse tree, one or more directed edges defining dependency between the plurality of code elements such that each directed edge couples two nodes associated with two different code elements. Further, the processing circuitry is configured to generate a context for at least one code element of the plurality of code elements. The context is indicative of the purpose of the at least one code element in the code block. Based on the parse tree with the one or more directed edges, the processing circuitry is further configured to split the code block into a plurality of chunks. Each chunk comprises at least one of a subset of the code block and one or more contexts of one or more code elements, of the plurality of code elements, present in the corresponding subset of the code block, respectively. The processing circuitry is further configured to process the plurality of chunks to generate an output associated with the code block.

In some embodiments, the parse tree comprises a plurality of sub-trees that represent the plurality of code elements. Each sub-tree, of the plurality of sub-trees, includes the corresponding plurality of nodes arranged in a hierarchical manner.

In some embodiments, the processing circuitry is further configured to pre-process the code block prior to the parsing of the code block.

In some embodiments, the code block further comprises a plurality of comments. The pre-processing of the code block results in removal of the plurality of comments from the code block.

In some embodiments, the code block corresponds to a procedural structured query language (SQL) code block.

In some embodiments, the output associated with the code block corresponds to a set of business rules associated with the code block.

In some embodiments, the processing circuitry is further configured to engineer an application based on the set of business rules associated with the code block. A codebase of the engineered application differs from a codebase of the code block.

In some embodiments, the processing circuitry generates the context for the at least one code element using a large language model.

In some embodiments, to generate the context for the parameter or the variable, the processing circuitry is further configured to process, using the large language model, a portion of the code block including the parameter or the variable.

In some embodiments, to generate the context for the condition, the processing circuitry is further configured to process, using the large language model, a portion of the code block including the condition, and the context generated for each parameter and variable present in the portion of the code block that includes the condition.

In some embodiments, to process each chunk of the plurality of chunks, the processing circuitry is further configured to generate a prompt for the corresponding chunk, and generate, using a large language model, a response to the generated prompt. The response corresponds to a set of business rules associated with the corresponding chunk.

In some embodiments, the processing circuitry is further configured to generate, using the large language model, the output associated with the code block based on a plurality of responses generated for the plurality of chunks. The output associated with the code block corresponds to the set of business rules associated with the code block in entirety.

In some embodiments, the processing circuitry is further configured to split the plurality of responses based on a query size limit of the large language model prior to the generation of the output.

In some embodiments, the system further comprises a storage element that is coupled to the processing circuitry.

In some embodiments, the storage element is configured to store a parameter table that includes a mapping between a set of parameters and a set of contexts of the set of parameters. During the splitting of the code block, if at least one parameter, of the set of parameters, is present in the subset of the code block, the processing circuitry is further configured to access the parameter table to obtain a context, of the one or more contexts, mapped to the at least one parameter.

In some embodiments, the storage element is configured to store a variable table that includes a mapping between a set of variables, a set of line numbers where the set of variables appear in the code block, and a set of contexts of the set of variables. During the splitting of the code block, if at least one variable, of the set of variables, is present in the subset of the code block, the processing circuitry is further configured to determine a line number range of the subset of the code block, access the variable table to identify a line number that is less than and nearest to the line number range, and obtain a context, of the one or more contexts, mapped to the at least one variable and the identified line number.

In some embodiments, the variable table includes a same variable appearing in two different line numbers of the code block having two different contexts.

In some embodiments, the storage element is configured to store a condition table that includes a mapping between a set of conditions and a set of contexts of the set of conditions. During the splitting of the code block, if at least one condition, of the set of conditions, is present in the subset of the code block, the processing circuitry is further configured to access the condition table to obtain a context, of the one or more contexts, mapped to the at least one condition.

In some embodiments, to split the code block, the processing circuitry is further configured to execute a depth-first traversal of the parse tree with the one or more directed edges, the one or more directed edges being used for code element dependency analysis.

In some embodiments, a count of tokens in the subset of the code block included in each chunk of the plurality of chunks is within a chunk size limit. The processing circuitry processes the plurality of chunks using a large language model. The chunk size limit is defined based on a query size limit of the large language model utilized for processing the plurality of chunks.

In another embodiment of the present disclosure, a method is disclosed. The method comprises parsing, by processing circuitry, a code block comprising a plurality of code elements. Each code element corresponds to one of a code block name, a parameter, a variable, a statement, or a condition. The method further comprises generating, by the processing circuitry, based on the parsing of the code block, a parse tree. The parse tree comprises a plurality of nodes for each code element of the plurality of code elements, with each node representing a token of the corresponding code element. The method further comprises generating, by the processing circuitry, in the parse tree, one or more directed edges defining dependency between the plurality of code elements such that each directed edge couples two nodes associated with two different code elements. Further, the method comprises generating, by the processing circuitry, a context for at least one code element of the plurality of code elements. The context is indicative of a purpose of the at least one code element in the code block. The method further comprises splitting, by the processing circuitry, based on the parse tree with the one or more directed edges, the code block into a plurality of chunks. Each chunk comprises at least one of a subset of the code block and one or more contexts of one or more code elements, of the plurality of code elements, present in the corresponding subset of the code block, respectively. Further, the method comprises processing, by the processing circuitry, the plurality of chunks to generate an output associated with the code block.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present disclosure are illustrated by way of example and are not limited by the accompanying figures. Similar references in the figures may indicate similar elements. Elements in the figures are illustrated for simplicity and clarity and have not necessarily been drawn to scale.

FIG. 1 is a schematic diagram that illustrates an environment for procedural structured query language (SQL) code analysis, consistent with disclosed embodiments of the present disclosure;

FIG. 2 is a block diagram of processing circuitry of the environment of FIG. 1, consistent with disclosed embodiments of the present disclosure;

FIG. 3 is a schematic diagram that illustrates an example parse tree with directed edges, consistent with disclosed embodiments of the present disclosure;

FIGS. 4A and 4B, collectively, represents a flowchart that illustrates a method for analyzing procedural SQL codes, consistent with disclosed embodiments of the present disclosure; and

FIG. 5 shows an example computing system for carrying out the methods of the present disclosure, consistent with disclosed embodiments of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

### Overview

With the advent of generative artificial intelligence (AI), large language models (LLMs) have emerged as a more efficient alternative to manual code analysis. Procedural structure query language (SQL) codes may be processed using LLMs via queries (e.g., prompts) to determine underlying business rules. LLMs, however, have a definite query size limit (e.g., a number of tokens that may be processed without the loss of context) which is typically significantly less than the size of the procedural SQL codes. A token may be a unit of text (e.g., a word, a sub-word, a character, or the like) of the code. The entire procedural SQL code may thus not be contextually processed using the LLM, and may be required to be split into smaller chunks such that a count of tokens in each chunk is within the query size limit of the LLM. This chunking is typically executed using code splitters and/or text splitters. The conventional splitters may abruptly split the large codes into smaller chunks disrupting the interconnectedness between code elements (e.g., parameters, variables, conditions, or the like). In other words, processing a chunk (e.g., a portion of the code) whose code elements (e.g., parameters, variables, conditions, or the like) are not defined in the same chunk may result in inaccurate business rule determination. Such error-laden business rules may result in the engineering of an erroneous application.

The present disclosure addresses the afore-mentioned limitations by providing a different technique of contextual code splitting for analyzing procedural SQL codes. In the present disclosure, a procedural SQL code block is parsed. The code block may include various code elements. A code element may correspond to a code block name, a parameter, a variable, a statement, or a condition. Based on the parsing of the code block, a parse tree is generated. The parse tree may include various nodes for each code element. Each node may represent a token of a code element. Further, in the parse tree, directed edges are generated. The directed edges define a dependency between the code elements such that each directed edge couples two nodes associated with two different code elements. Contexts are then generated for some code elements (e.g., parameters, variables, conditions, or the like). A context may be indicative of a purpose of a code element in the code block. The context may be generated using an LLM.

Based on the parse tree with the directed edges, the code block is split into chunks. Each chunk may include a subset of the code block and contexts of code elements present in the corresponding subset of the code block. The chunks may be processed to generate an output associated with the code block. To process each chunk, a prompt is generated for the chunk and a response to the generated prompt is generated using an LLM. The response may correspond to business rules associated with the corresponding chunk. The output associated with the code block may be generated based on responses generated for all the chunks. The output may thus correspond to business rules associated with the code block in entirety. A new application may then be engineered based on the business rules associated with the code block. The new application may be engineered in accordance with modern programming languages.

The use of contexts in each chunk ensures that all code elements (such as parameters, variables, conditions, or the like) that are present in the portion of the code block included in the chunk are contextually defined prior to the chunk processing. By enabling precise, context-aware code splitting, accurate extraction of critical business rules may be implemented. Accurate business rule extraction may further facilitate accurate application engineering. The contextual code splitting may bridge the structural gap between procedural and object-oriented paradigms, facilitating smoother migrations while preserving the integrity of the original logic. The present disclosure generates context for providing the purpose of a code element in a code portion to maintain continuity of historical information of the previous code chunks with the current code chunk, thereby eliminating the drawbacks of loss of historical information.

The present disclosure may promote better maintainability and scalability by producing modular, reusable code, thereby making future updates and changes more manageable. Additionally, this approach may minimize manual effort, reduce errors, and may provide a clearer understanding of legacy code dependencies, rendering this approach highly adaptable and suitable for various object-oriented languages. This may ultimately help organizations future-proof their applications by ensuring efficient migration, better code quality, and long-term sustainability. The application area of the present disclosure may include any domain that requires analysis of procedural SQL codes. It is appreciated that the human mind may not be equipped to conceptualize and engineer accurate, effective, dynamic, and precise analysis of procedural SQL codes to extract business rules based on contextual code splitting using a parse tree with directed edges, given the digital interconnectedness of contextual splitting of the codes.

### Figure Description

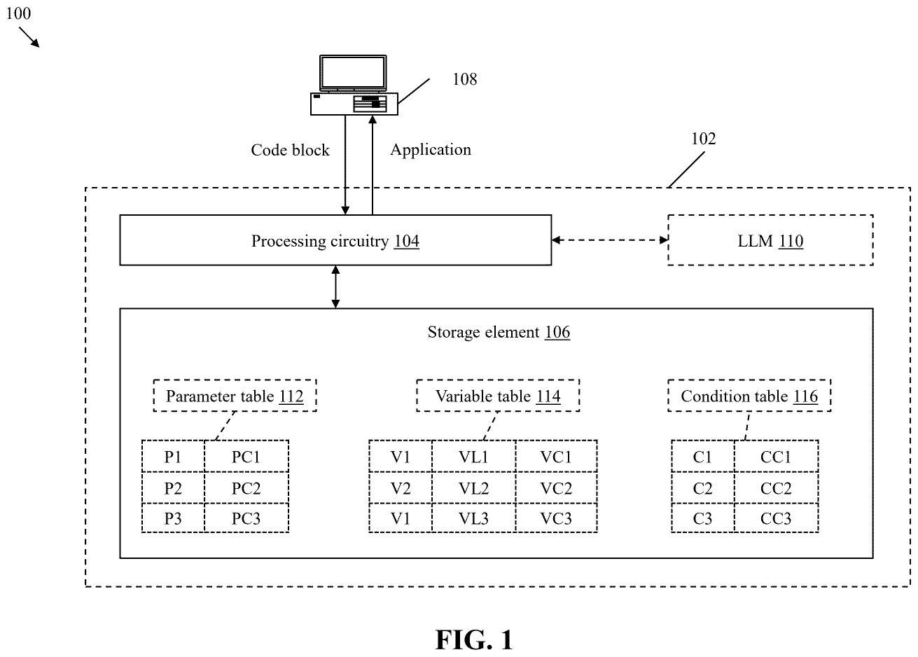

FIG. 1 is a schematic diagram that illustrates an environment 100 for procedural structured query language (SQL) code analysis, consistent with disclosed embodiments of the present disclosure.

Procedural SQL was widely used for developing legacy applications in various domains (e.g., large financial institutions), but advancements in computer science have shifted the preference toward modern programming languages, such as object-oriented languages, for better security, code reusability, and modularity. Organizations relying on procedural SQL now face the challenge of migrating to modern languages, a complex process due to fundamental differences in paradigms. This necessitates a two-step approach: analyzing the procedural SQL code to extract business rules and then engineering a new application using these rules. A procedural SQL code block may include various code elements such as a code block name, a parameter, a variable, a statement, a condition, or the like. The code elements may be responsible for various purposes, such as holding data, performing required actions, or handling errors. Manual analysis of the procedural SQL code block is labor-intensive, especially for large, poorly documented codebases, making the migration process time-consuming and error prone.

Generative artificial intelligence (AI) and large language models (LLMs) offer a more efficient alternative for analyzing the procedural SQL code. LLMs process the procedural SQL code via queries (e.g., prompts) to extract business rules but are limited by a fixed query size limit, restricting the number of tokens processed at once. To address this, large procedural SQL codes must be split into smaller chunks using code or text splitters. However, conventional splitters may disrupt the interconnectedness of code elements (e.g., parameters, variables, conditions, or the like), leading to inaccurate business rule extraction and potentially flawed application development.

To overcome these challenges, a context-based code splitting technique is disclosed in the present disclosure. The environment 100 may include a code management system 102 that may be configured to execute the context-based code splitting technique. The code management system 102 may be configured to split a large procedural SQL code into smaller chunks. Each chunk may include a portion of the code, with a count of tokens of the code portion being within a chunk size limit. Each chunk may also include contexts of the code elements present in the code portion. A context may indicate a purpose of the code element in the code portion.

The code management system 102 may be further configured to process the chunks to generate an output associated with the large procedural SQL code. To process each chunk, the code management system 102 may be configured to generate a prompt for the chunk and generate a response to the generated prompt. The response may correspond to business rules associated with the corresponding chunk. The output associated with the large procedural SQL code may be generated based on responses generated for all the chunks. The output may thus correspond to business rules associated with the large procedural SQL code in its entirety. Based on the business rules, the code management system 102 may be further configured to engineer a new application in accordance with modern programming languages.

The use of contexts in each chunk ensures that all code elements (such as parameters, variables, conditions, or the like) that are present in the code portion included in the chunk are contextually defined prior to the chunk processing. By enabling precise, context-aware code splitting, accurate extraction of critical business rules may be implemented. Accurate business rule extraction may further facilitate accurate engineering of the new application. The contextual code splitting may bridge the structural gap between procedural and object-oriented paradigms, facilitating smoother migrations while preserving the integrity of the original logic. The present disclosure generates context for providing a purpose of a code element in a code portion to maintain continuity of historical information of the previous code chunks with the current code chunk, thereby eliminating the drawbacks of loss of historical information.

### Code Management System 102

To execute the aforementioned operations, the code management system 102 may include processing circuitry 104 and a storage element 106. The storage element 106 may correspond to hardware storage (for example, hard drive, solid-state drive, or the like) or cloud storage (for example, cloud services). The processing circuitry 104 may be coupled to the storage element 106. The processing circuitry 104 may include suitable logic, circuitry, interfaces, and/or code, executable by the circuitry, that may be configured to execute the context-based code splitting technique of the present disclosure.

The processing circuitry 104 may be configured to receive a procedural SQL code block. The environment 100 may include a user device 108 that may be coupled to the processing circuitry 104. The user device 108 may correspond to a cellphone, a laptop, a tablet, a phablet, a desktop, a computer, or the like. The user device 108 may be associated with a user (not shown). The user device 108 may include suitable logic, circuitry, interfaces, and/or code, executable by the circuitry, that may be configured to perform one or more operations for interacting with the processing circuitry 104. For example, the user device 108 may be used by the user to provide the procedural SQL code block to the processing circuitry 104.

In an example, the procedural SQL code block may correspond to a procedural language/structured query language (PL/SQL) code block. In another example, the procedural SQL code block may correspond to a Transact SQL code block. However, in other embodiments, different procedural SQL code blocks may be utilized. The procedural SQL code block is hereinafter referred to as the “code block”.

The procedural SQL code block may include a plurality of code elements. Each code element, of the plurality of code elements, may correspond to one of a code block name, a parameter, a variable, a statement, or a condition. The code block name may correspond to an identifier assigned to the code block. The parameter may be defined in a function or a procedure to accept input values, whereas the variable may be a named storage location that holds data and may change during execution. The statement may be a single instruction in a program that performs an action. Further, the condition may be a logical expression that evaluates to true or false, controlling the flow of execution. Examples of the condition may include an if-then statement, an if-then-else statement, an if-then-elseif-else-statement, a for loop statement, a while loop statement, or the like.

The processing circuitry 104 may be further configured to parse the code block. In an embodiment, the processing circuitry 104 may be configured to pre-process the code block prior to the parsing of the code block. The code block may further include a plurality of comments. A comment may be a non-executable annotation in the code block used to describe functionality or improve readability. The pre-processing of the code block may result in removal of the plurality of comments from the code block.

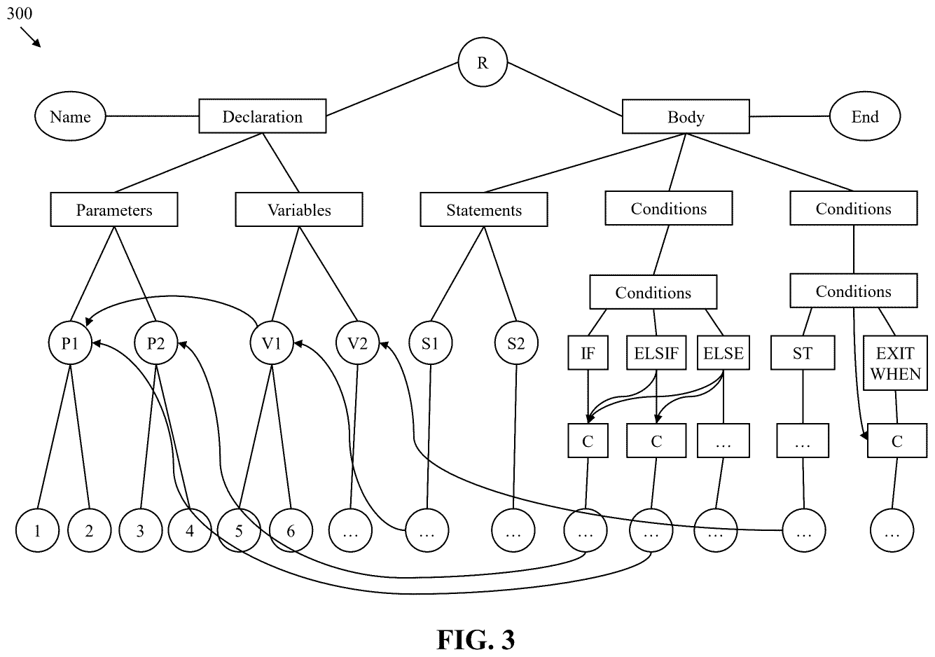

Based on the parsing of the comment-free code block, the processing circuitry 104 may be further configured to generate a parse tree. The parse tree may include a plurality of nodes for each code element of the plurality of code elements. Each node may represent a token of the corresponding code element. A token may be a unit of text (e.g., a word, a sub-word, a character, or the like) of the code. In an embodiment, the parse tree may include a plurality of sub-trees that represent the plurality of code elements. Each sub-tree, of the plurality of sub-trees, may include the corresponding plurality of nodes arranged in a hierarchical manner. Further, in the parse tree, the processing circuitry 104 may be configured to generate one or more directed edges defining dependency between the plurality of code elements such that each directed edge couples two nodes associated with two different code elements. The one or more directed edges may be generated in the parse tree based on the parsing of the code block. For example, if one sub-tree corresponds to a variable and another sub-tree corresponds to a condition, a node of the condition sub-tree may be coupled to a node of the variable sub-tree by way of a directed edge. The directed edge may indicate that the variable represented by the node of the variable sub-tree is utilized in the code portion representing the condition. Such directed edges may provide the necessary context required during the processing of condition code portions that are split across different chunks. The parse tree with the one or more directed edges is described in detail in conjunction with FIG. 3.

The processing circuitry 104 may be configured to generate a context for at least one code element of the plurality of code elements. The context may be indicative of a purpose of the at least one code element in the code block. The processing circuitry 104 may generate the context for the at least one of the plurality of code elements using an LLM 110. Examples of the LLM 110 may include Generative Pre-trained Transformer (GPT)-3, GPT-4, Bidirectional Encoder Representations from Transformers (BERT), or the like. However, in other embodiments, different LLMs may be utilized. The processing circuitry 104 may thus generate contexts for some code elements of the code block. Examples of such code elements may include variables, parameters, conditions, or the like.

To generate the context for the parameter or the variable, the processing circuitry 104 may be further configured to process, using the LLM 110, a portion of the code block including the parameter or the variable. On the other hand, to generate the context for the condition, the processing circuitry 104 may be further configured to process, using the LLM 110, a portion of the code block including the condition, and the context generated for each parameter and variable present in the portion of the code block that includes the condition.

Thus, after parsing the entire code block, the processing circuitry 104 may be configured to generate a plurality of contexts for various parameters, variables, and conditions present in the code block and store the generated contexts in the storage element 106. In an embodiment, the storage element 106 may be configured to store a parameter table 112 that includes a mapping between a set of parameters and a set of contexts of the set of parameters. As illustrated in FIG. 1, the parameter table 112 may include three parameters ‘P1’, ‘P2’, and ‘P3’ with three parameter contexts ‘PC1’, ‘PC2’, and ‘PC3’ mapped thereto, respectively. The parameter contexts ‘PC1’, ‘PC2’, and ‘PC3’ may define the purpose of the parameters ‘P1’, ‘P2’, and ‘P3’ in the code block, respectively.

The storage element 106 may be further configured to store a variable table 114 that includes a mapping between a set of variables, a set of line numbers where the set of variables appear in the code block, and a set of contexts of the set of variables. The set of line numbers is included in the variable table 114 as the variable may be defined differently in different portions of the code block. As illustrated in FIG. 1, the variable table 114 may include two variables ‘V1’ and ‘V2’, with the variable ‘V1’ appearing at line numbers ‘VL1’ and ‘VL3’ and the variable ‘V2’ appearing at the line number ‘VL2’. The variable table 114 may further include a variable context ‘VC1’ mapped to the variable ‘V1’ and the line number ‘VL1’, the variable context ‘VC1’ defining the purpose of the variable ‘V1’ at the line number ‘VL1’ of the code block. The variable table 114 may further include a variable context ‘VC2’ mapped to the variable ‘V2’ and the line number ‘VL2’, the variable context ‘VC2’ defining the purpose of the variable ‘V2’ at the line number ‘VL2’ of the code block. Further, the variable table 114 may include a variable context ‘VC3’ mapped to the variable ‘V1’ and the line number ‘VL3’, the variable context ‘VC3’ defining the purpose of the variable ‘V1’ at the line number ‘VL3’ of the code block. The variable table 114 may thus include a same variable appearing in two different line numbers of the code block having two different contexts. For example, in line 1, a variable may indicate a summation of three values, whereas in line 5, the same variable may indicate an average of three values.

The storage element 106 may be further configured to store a condition table 116 that includes a mapping between a set of conditions and a set of contexts of the set of conditions. As illustrated in FIG. 1, the condition table 116 may include three conditions ‘C1’, ‘C2’, and ‘C3’ with three condition contexts ‘CC1’, ‘CC2’, and ‘CC3’ mapped thereto, respectively. The condition contexts ‘CC1’, ‘CC2’, and ‘CC3’ may define the purpose of the conditions ‘C1’, ‘C2’, and ‘C3’ in the code block, respectively.

Although FIG. 1 describes the storage element 106 storing three tables (e.g., the parameter table 112, the variable table 114, and the condition table 116), the scope of the present disclosure is not limited to it. In several embodiments, tables corresponding to other code elements may be stored in the storage element 106 in the similar manner as described above.

The processing circuitry 104 may be further configured to split the code block into a plurality of chunks based on the parse tree with the one or more directed edges. In an embodiment, to split the code block, the processing circuitry 104 may be further configured to execute a depth-first traversal of the parse tree with the one or more directed edges, the one or more directed edges being used for code element dependency analysis. In an example, the depth-first traversal may correspond to a left-to-right depth-first traversal. However, in other embodiments, other depth-first traversal techniques may be utilized.

Each chunk, of the plurality of chunks, may include at least one of a subset of the code block and one or more contexts of one or more code elements, of the plurality of code elements, present in the corresponding subset of the code block, respectively. A count of tokens in the subset of the code block included in each chunk of the plurality of chunks is within a chunk size limit. The chunk size limit refers to the maximum allowable size of a code chunk that may be processed at once. For example, if a chunk size limit is set to 4000 tokens, each chunk of the code block may not exceed 4000 tokens.

In an embodiment, during the splitting of the code block, if at least one parameter included in the parameter table 112 is present in the subset of the code block, the processing circuitry 104 may be further configured to access the parameter table 112 to obtain a context, of the one or more contexts, mapped to the at least one parameter. Further, during the splitting of the code block, if at least one variable included in the variable table 114 is present in the subset of the code block, the processing circuitry 104 may be configured to determine a line number range of the subset of the code block, access the variable table 114 to identify a line number that is less than and nearest to the line number range, and obtain a context, of the one or more contexts, mapped to the at least one variable and the identified line number. For example, if the subset of the code block spans lines 150 to 190 of the code block and the nearest line number included in the variable table 114 for the particular variable is 110, the corresponding mapped context is obtained. During the splitting of the code block, if at least one condition included in the condition table 116 is present in the subset of the code block, the processing circuitry 104 may be further configured to access the condition table 116 to obtain a context, of the one or more contexts, mapped to the at least one condition.

Thus, the processing circuitry 104 may be configured to access the storage element 106 to obtain the one or more contexts of the one or more code elements, respectively, that are present in each chunk. In simple terms, the contexts from parameters, variables, and conditions along with the code portion constitute a chunk. A context may be a single-line comment.

The processing circuitry 104 may be further configured to process the plurality of chunks to generate an output associated with the code block. To process each chunk of the plurality of chunks, the processing circuitry 104 may be further configured to generate a prompt for the corresponding chunk and generate, using the LLM 110, a response to the generated prompt. The response may correspond to a set of business rules associated with the corresponding chunk. The LLM 110 may perform syntax and semantic analysis of the code to understand the structure of the code block involving the relationships of the code elements, followed by identifying potential business rules based on understanding the patterns in the code block.

The processing circuitry 104 may be further configured to generate, using the LLM 110, the output associated with the code block based on a plurality of responses generated for the plurality of chunks. The output associated with the code block may thus correspond to the set of business rules associated with the code block in entirety. In an embodiment, the processing circuitry 104 may be further configured to split the plurality of responses based on a query size limit of the LLM 110 prior to the generation of the output. The query size limit may define the count of tokens that the LLM 110 may process without losing historical information. In simple terms, the query size limit refers to the maximum number of tokens that the LLM 110 may process while still maintaining the context of the conversation. If the input exceeds this limit, the LLM 110 may lose historical information. Further, the chunk size limit may be defined based on the query size limit of the LLM 110 utilized for processing the plurality of chunks. In an embodiment, the chunk size limit may be equal to 70% of the query size limit of the LLM 110. In such a scenario, the remaining 30% of the query size limit may be utilized for the one or more contexts. However, in other embodiments, the chunk size limit may have different values.

The processing circuitry 104 may be further configured to engineer an application based on the set of business rules associated with the code block. A codebase of the engineered application may differ from a codebase of the code block. For example, the codebase of the code block may be procedural SQL, whereas the codebase of the engineered application may be an object-oriented programming language. The processing circuitry 104 may be further configured to render the engineered application on the user device 108. In an embodiment, the processing circuitry 104 may be further configured to render the set of business rules associated with the code block on the user device 108.

Although FIG. 1 describes the extraction of business rules from the procedural SQL code blocks, the scope of the present disclosure is not limited to it. In numerous embodiments, the output associated with the code block may correspond to a pseudocode, without deviating from the scope of the present disclosure.

Although it is described that the same LLM (e.g., the LLM 110) is utilized for the generation of contexts, responses, and the output, the scope of the present disclosure is not limited to it. In several embodiments, different LLMs may be utilized, without deviating from the scope of the present disclosure.

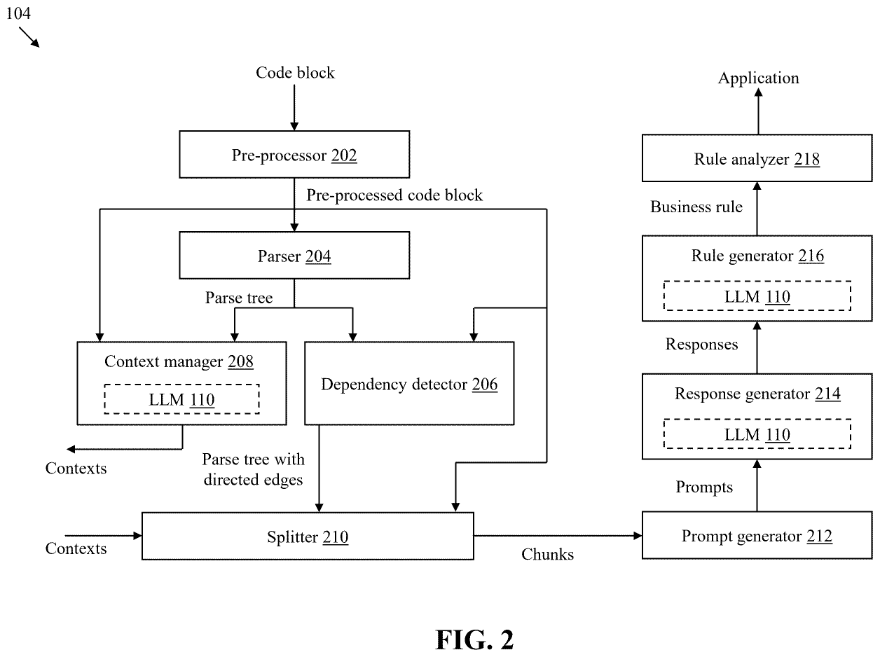

FIG. 2 is a block diagram of the processing circuitry 104, consistent with disclosed embodiments of the present disclosure. As illustrated in FIG. 2, the processing circuitry 104 may include a pre-processor 202, a parser 204, a dependency detector 206, a context manager 208, a splitter 210, a prompt generator 212, a response generator 214, a rule generator 216, and a rule analyzer 218.

The pre-processor 202 may be coupled to the user device 108. The pre-processor 202 may include suitable logic, circuitry, interfaces, and/or code, executable by the circuitry, that may be configured to perform one or more operations. For example, the pre-processor 202 may be configured to receive the code block from the user device 108. The code block comprises the plurality of comments and the plurality of code elements. The pre-processor 202 may be configured to pre-process the code block. The pre-processing of the code block may result in the removal of the plurality of comments from the code block.

The parser 204 may be coupled to the pre-processor 202. The parser 204 may include suitable logic, circuitry, interfaces, and/or code, executable by the circuitry, that may be configured to perform one or more operations. For example, the parser 204 may be configured to receive the pre-processed code block from the pre-processor 202 and parse the pre-processed code block. Based on the parsing of the pre-processed code block, the parser 204 may be further configured to generate the parse tree. The parse tree may include a plurality of nodes for each code element of the plurality of code elements. Each node may represent a token of the corresponding code element (e.g., a token of the code portion including the corresponding code element).

The dependency detector 206 may be coupled to the parser 204 and the pre-processor 202. The dependency detector 206 may include suitable logic, circuitry, interfaces, and/or code, executable by the circuitry, that may be configured to perform one or more operations. For example, the dependency detector 206 may be configured to receive the pre-processed code block and the parse tree from the pre-processor 202 and the parser 204, respectively. The dependency detector 206 may be further configured to determine, in the pre-processed code block, dependencies between multiple code elements. In an example, a dependency may indicate the utilization of a variable in a condition code portion (e.g., a portion of the code that corresponds to a condition). Further, in the parse tree, the dependency detector 206 may be configured to generate directed edges defining dependency between the code elements such that each directed edge couples two nodes associated with two different code elements.

The context manager 208 may be coupled to the parser 204 and the pre-processor 202. The context manager 208 may include suitable logic, circuitry, interfaces, and/or code, executable by the circuitry, that may be configured to perform one or more operations. For example, the context manager 208 may be configured to receive the pre-processed code block and the parse tree from the pre-processor 202 and the parser 204, respectively. The context manager 208 may be configured to generate, using the LLM 110, contexts for various code elements. A context may be indicative of the purpose of a code element in the code block. The context manager 208 may be further configured to store the generated contexts in the storage element 106. In an embodiment, the parameter contexts are stored in the parameter table 112, the variable contexts are stored in the variable table 114, and the condition contexts are stored in the condition table 116.

The splitter 210 may be coupled to the dependency detector 206, the pre-processor 202, and the storage element 106. The splitter 210 may include suitable logic, circuitry, interfaces, and/or code, executable by the circuitry, that may be configured to perform one or more operations. For example, the splitter 210 may be configured to receive the parse tree with the directed edges from the dependency detector 206. The splitter 210 may be further configured to receive the pre-processed code block from the pre-processor 202. Further, the splitter 210 may be configured to split the pre-processed code block into chunks based on the parse tree with the directed edges. In an embodiment, to split the code block, the splitter 210 may be further configured to execute the depth-first traversal of the parse tree with the directed edges, the directed edges being used for code element dependency analysis. Each chunk may include a code portion (e.g., a subset of the code block) and one or more contexts of one or more code elements present in the corresponding code portion, respectively. A count of tokens in the subset of the code block included in each chunk is within the chunk size limit.

In an embodiment, during the splitting of the code block, if a parameter is present in the code portion, the splitter 210 may be further configured to access the parameter table 112 to obtain a context mapped to the corresponding parameter. Further, if a variable is present in the code portion, the splitter 210 may be further configured to determine a line number range of the code portion, access the variable table 114 to identify a line number that is less than and nearest to the line number range, and obtain a context mapped to the corresponding variable and the identified line number. Similarly, if a condition is present in the code portion, the splitter 210 may be further configured to access the condition table 116 to obtain a context mapped to the corresponding condition. Thus, the splitter 210 may be configured to access the storage element 106 to obtain the one or more contexts of the one or more code elements, respectively, that are present in each chunk.

The prompt generator 212 may be coupled to the splitter 210. The prompt generator 212 may include suitable logic, circuitry, interfaces, and/or code, executable by the circuitry, that may be configured to perform one or more operations. For example, the prompt generator 212 may be configured to receive the generated chunks from the splitter 210. The prompt generator 212 may be further configured to generate a prompt for each chunk.

The response generator 214 may be coupled to the prompt generator 212. The response generator 214 may include suitable logic, circuitry, interfaces, and/or code, executable by the circuitry, that may be configured to perform one or more operations. For example, the response generator 214 may be configured to receive the prompts from the prompt generator 212. The response generator 214 may be further configured to generate, using the LLM 110, a response for each prompt. The response corresponds to a business rule associated with a chunk.

The rule generator 216 may be coupled to the response generator 214. The rule generator 216 may include suitable logic, circuitry, interfaces, and/or code, executable by the circuitry, that may be configured to perform one or more operations. For example, the rule generator 216 may be configured to receive the responses from the response generator 214. The rule generator 216 may be configured to generate, using the LLM 110, a business rule associated with the code block based on the responses. In an embodiment, all the responses may be input to the LLM 110 together to generate the code block business rule. In another embodiment, the rule generator 216 may be further configured to split the responses based on the query size limit of the LLM 110. For instance, if the total token size of the responses is larger than the query size limit of the LLM 110, the responses may be split into smaller chunks and processed sequentially using the LLM 110 to generate the code block business rule.

The rule analyzer 218 may be coupled to the rule generator 216. The rule analyzer 218 may include suitable logic, circuitry, interfaces, and/or code, executable by the circuitry, that may be configured to perform one or more operations. For example, the rule analyzer 218 may be configured to receive the business rule associated with the code block from the rule generator 216. The rule analyzer 218 may be further configured to engineer the application based on the business rule associated with the code block. The codebase of the engineered application differs from the codebase of the code block.

Engineering an application involves transforming codebase logic into a more modular and maintainable structure. For example, re-engineering SQL code to an object-oriented programming (OOP) codebase involves transforming database logic into a more modular and maintainable structure using OOP principles. The tables in the databases containing SQL code elements are mapped to OOP classes, with each row in a table becoming an object instance of the class. SQL operations such as select, insert, update, and delete are translated into methods within the OOP classes. Relationships between tables, represented by foreign keys, are converted into object references between classes. Crud operations are turned into methods. This re-engineering enhances modularity, reusability, maintainability, and scalability. The rule analyzer 218 may be further configured to render the engineered application on the user device 108.

FIG. 3 is a schematic diagram that illustrates an example parse tree with directed edges 300, consistent with disclosed embodiments of the present disclosure. The parse tree with directed edges 300 is hereinafter referred to as the “directed parse tree 300”. The directed parse tree 300 provides an enhanced representation of the code block with the code elements, incorporating both syntactic relationships and dependencies between various code elements such as parameters, variables, conditions, or the like.

The directed parse tree 300 may include various nodes. Each node may have a unique identifier. As illustrated in FIG. 3, the terminal nodes (e.g., leaves) represent the tokens in the code, such as keywords, identifiers, and operators, while the non-terminal nodes represent higher-level constructs such as statements, expressions, functions, conditions, or the like. Each token is arranged in an order representing a hierarchical relationship between the code elements. For example, the directed parse tree 300 represents a parent-child relationship derived from the code block. The directed parse tree 300 starts from a root node denoted as ‘R’. The parent nodes ‘name’, ‘declaration’, ‘body’, and ‘end’ are connected to the ‘R’. The parent nodes are connected to their respective child nodes. For example, the child node ‘parameters’and ‘variables’are connected to the parent node ‘declaration’, whereas the child node ‘statements’ and ‘conditions’are connected to the parent node ‘body’.

The node ‘P1’ and value nodes ‘1’ and ‘2’ form a first sub-tree, and the node ‘P2’ and value nodes ‘3’ and ‘4’ form a second sub-tree corresponding to the parameters. Similarly, the nodes ‘V1’, ‘5’, and ‘6’ form a third sub-tree corresponding to the variable. It should be appreciated that the references to ‘first sub-tree,’ ‘second sub-tree,’ and ‘third sub-tree’ or other similar terms are not intended to refer to specific sub-trees but are used for distinguishing elements.

The dependency between the nodes is indicated by generating directed edges between the nodes. For example, directed edges may be created from conditions to their respective parameters and variables and may also be created between variables and parameters. For example, a directed edge couples a variable node ‘V1’ and a parameter node ‘P1’. Further, another directed edge couples a token of ‘Elsif’ condition and the parameter node ‘P1’. The directed edges couple a token of ‘If’ condition and a parameter node ‘P2’, a token of condition and a variable node ‘V2’, and a token of statement with the variable node ‘V1’. Control flow dependencies are captured with directed edges as well. For example, the directed edges may also couple various conditions such as ‘If’, ‘Elsif’, and ‘Else’. In an ‘if-else’ condition block, directed edges are created from the ‘else’ and ‘elsif’ blocks back to the condition node, maintaining the flow of control. Further, in a loop, the directed edges may couple the loop node to its condition, indicating that the loop depends on that condition to continue or terminate. Although not shown, the directed parse tree 300 may include more directed edges without deviating from the scope of the invention.

Starting at the root node, a parse tree is explored by traversing each node, identifying dependencies, and creating the necessary directed edges, thereby generating the directed parse tree 300. For each parameter and variable node, directed edges are added to represent their dependencies in the code, linking them to the nodes where they are used. For conditional statements such as conditions and loops, edges are created between condition nodes and their corresponding blocks (‘else’, ‘elsif’, or loop exit conditions).

The directed parse tree 300 is traversed based on a left-to-right depth-first approach. In a Depth-First Search (DFS) traversal, the process begins at the root node (R). To start, the splitter 210 first moves to the leftmost child, in this case, ‘Name’. Once ‘Name’ is fully explored, the splitter 210 backtracks and moves to the next child of the root, ‘Declaration’, which has two main child nodes: ‘Parameters’and ‘Variables’. The splitter 210 follows the left-to-right rule, and explores ‘Parameters’first. Within ‘Parameters’, there are two child nodes: ‘P1’ and ‘P2’. The splitter 210 dives deeper into ‘P1’ and traverses its children ‘1’ and ‘2’ and then moves to ‘P2’, which is explored by traversing ‘3’ and ‘4’. After finishing ‘Parameters’, the splitter 210 moves to the ‘Variables’, exploring child nodes ‘V1’ and ‘V2’ in a similar manner. Once ‘Variables’are fully traversed, the splitter 210 continues to the ‘Statements’ node, which contains two children: ‘S1’ and ‘S2’. The splitter 210 traverses ‘S1’ first, and then moves to ‘S2’. After finishing with ‘Statements’, the traversal moves to ‘Body’, which contains the multiple ‘Conditions’having several children, including ‘IF’, ‘ELSIF’, ‘ELSE’, ‘EXIT WHEN’, and ‘Statement’. After all conditions are traversed, the splitter 210 ends with the final node, End, signaling the completion of the traversal.

Throughout the DFS process, the traversal consistently follows a left-to-right order, visiting the deepest nodes first and only backtracking when no further nodes may be explored based on directed edges. This traversal is based on LIFO (Last-In-First-Out) behavior, ensuring that the directed parse tree 300 delves as deeply as possible into each branch before returning to explore other branches. By following this approach, DFS systematically covers all nodes in a tree structure, exploring each node in depth before backtracking to previous nodes.

Cyclic dependencies may arise in the parse tree, particularly with loops and conditional branches, where a condition in a loop or an ‘if-else’ block refers to previous conditions or blocks. These cyclic relationships are carefully managed during traversal, ensuring the logical flow of the program is preserved. For example, in a loop, the directed edge from the loop node to its condition allows for the cyclical nature of the loop to be captured. The directed edges may thus represent the right context in each chunk of the code and may be utilized to retain the accurate logic when the code is chunked. This parse tree, with its directed edges and careful traversal, enables a deeper understanding of the code's structure, dependencies, and flow. By maintaining the integrity of the code's dependencies and relationships, the directed parse tree 300 provides a powerful mechanism for efficient and effective code analysis.

During the traversal, the code block is chunked based on the size of sub-trees under each node, ensuring that chunks do not exceed the chunk size limit. If a chunk exceeds this limit, the sub-tree is split into smaller chunks, with statement nodes remaining intact to preserve their structure. This ensures that the business rules embedded in the code are accurately extracted without losing context.

For each node, if the number of leaves under a sub-tree of the current node is within the chunk size limit, all tokens from the leaves are merged to generate a chunk. If the number of leaves under the sub-tree of the current node and the nodes in the current chunk are more than the chunk size limit, splitting the sub-tree under the current node is required. The process for splitting the sub-tree under a node is explained below.

If the current node corresponds to a statement, it cannot be split. All the leaves of the statement node are added to the current chunk. If the current node is a Condition or LOOP node, the current chunk is ended and a new chunk is created from the Condition or LOOP node. The statements under the Condition or LOOP node are added into a new chunk. If the current node is an ELSE or ELSIF block, the current chunk is ended and a new chunk is created from the ELSE and ELSIF node. The statements under the ELSE and ELSIF nodes are added into a new chunk. The process is repeated until all the leaf nodes of the parse representation are added to the last chunk.

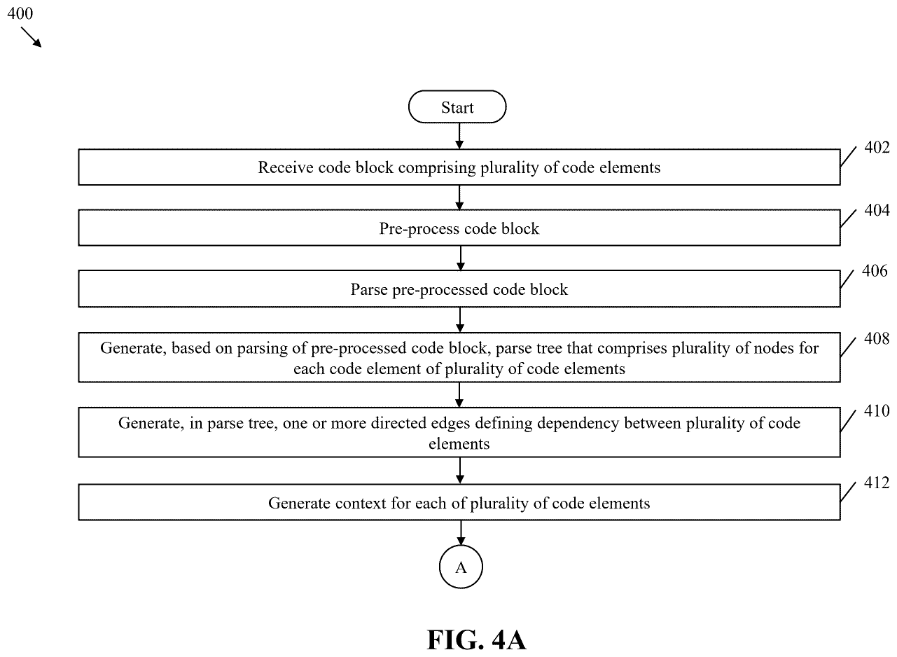

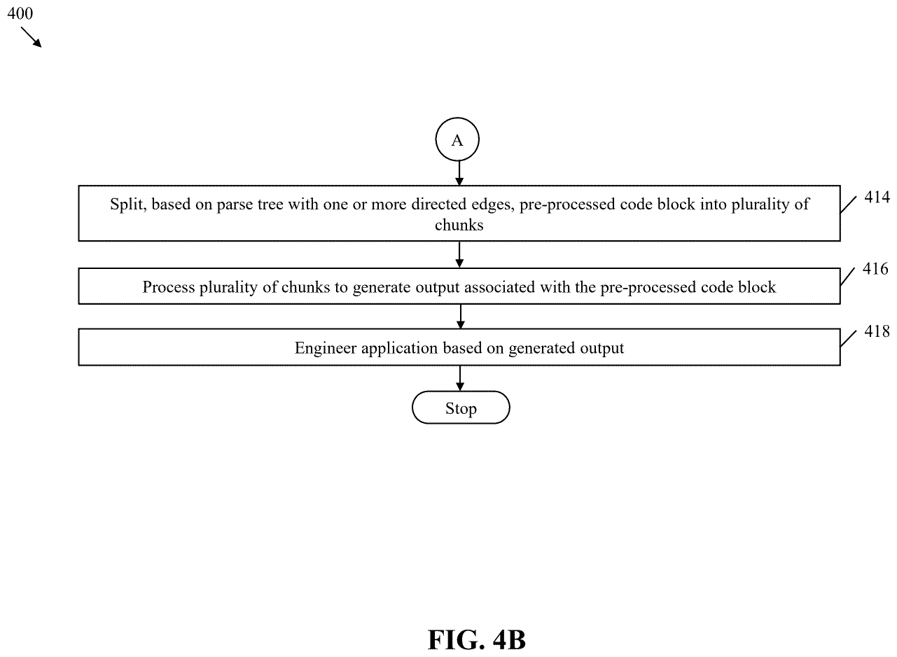

FIGS. 4A and 4B, collectively, represents a flowchart 400 that illustrates a method for analyzing procedural SQL codes, consistent with disclosed embodiments of the present disclosure.

Referring to FIG. 4A, at 402, the processing circuitry 104 (e.g., the pre-processor 202) may receive a code block comprising of plurality of code elements. At 404, the processing circuitry 104 (e.g., the pre-processor 202) may pre-process the code block. At 406, the processing circuitry 104 (e.g., the parser 204) may parse the pre-processed code block. At 408, the processing circuitry 104 (e.g., the parser 204) may generate, based on the parsing of the pre-processed code block, a parse tree that comprises a plurality of nodes for each code element of the plurality of code elements. Each node represents a token of the corresponding code element. At 410, the processing circuitry 104 (e.g., the dependency detector 206) may generate, in the parse tree, one or more directed edges defining dependency between the plurality of code elements. Each directed edge may couple two nodes associated with two different code elements. At 412, the processing circuitry 104 (e.g., the context manager 208) may generate a context for each of the plurality of code elements. The context may be indicative of a purpose of the corresponding code element in the pre-processed code block.

Referring to FIG. 4B, at 414, the processing circuitry 104 (e.g., the splitter 210) may split, based on the parse tree with the one or more directed edges, the pre-processed code block into a plurality of chunks. Each chunk may include at least one of a subset of the pre-processed code block and one or more contexts of one or more code elements, of the plurality of code elements, present in the corresponding subset of the code block, respectively. At 416, the processing circuitry 104 (e.g., the prompt generator 212, the response generator 214, and the rule generator 216 using the LLM 110) may process the plurality of chunks to generate an output associated with the pre-processed code block. At 418, the processing circuitry 104 (e.g., the rule analyzer 218) may engineer an application based on the generated output. In such a scenario, the output may correspond to the set of business rules associated with the pre-processed code block.

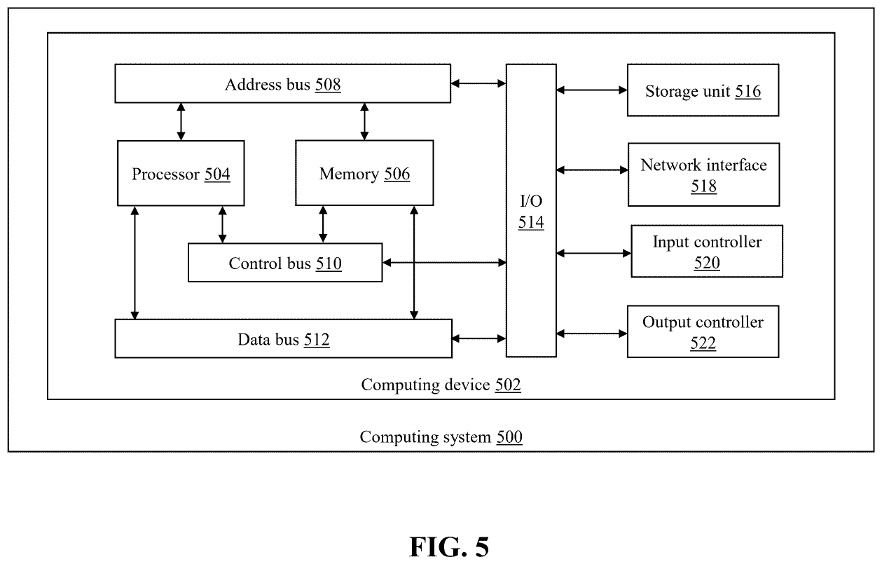

FIG. 5 shows an example computing system 500 for carrying out the methods of the present disclosure, consistent with disclosed embodiments of the present disclosure. Specifically, FIG. 5 shows a block diagram of an embodiment of the computing system 500 according to example embodiments of the present disclosure.

The computing system 500 may be configured to perform any of the operations disclosed herein. The computing system 500 may be implemented as a conventional computer system, an embedded controller, a laptop, a server, a mobile device, a smartphone, a customized machine, any other hardware platform, or any combination or multiplicity thereof. In one embodiment, the computing system 500 is a distributed system configured to function using multiple computing machines interconnected via a data network or bus system.

The computing system 500 includes computing devices (such as a computing device 502). The computing device 502 includes one or more processors (such as a processor 504) and a memory 506. The processor 504 may be any general-purpose processor(s) configured to execute a set of instructions. For example, the processor 504 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a controller, a state machine, gated logic, discrete hardware component, any other processing unit, or any combination or multiplicity thereof. In one embodiment, the processor 504 may be multiple processing units, a single processing core, multiple processing cores, special purpose processing cores, co-processors, or any combination thereof. The processor 504 may be communicatively coupled to the memory 506 via an address bus 508, a control bus 510, and a data bus 512.

The memory 506 may include non-volatile memories such as a read-only memory (ROM), a programable read-only memory (PROM), an erasable programmable read-only memory (EPROM), a flash memory, or any other device capable of storing program instructions or data with or without applied power. The memory 506 may also include volatile memories, such as a random-access-memory (RAM), a static random-access-memory (SRAM), a dynamic random-access-memory (DRAM), and a synchronous dynamic random-access-memory (SDRAM). The memory 506 may include single or multiple memory modules. While the memory 506 is depicted as part of the computing device 502, a person skilled in the art will recognize that the memory 506 may be separate from the computing device 502.

The memory 506 may store information that may be accessed by the processor 504. For instance, the memory 506 (e.g., one or more non-transitory computer-readable storage mediums, memory devices) may include computer-readable instructions (not shown) that may be executed by the processor 504. The computer-readable instructions may be software written in any suitable programming language or may be implemented in hardware. Additionally, or alternatively, the computer-readable instructions may be executed in logically and/or virtually separate threads on the processor 504. For example, the memory 506 may store instructions (not shown) that when executed by the processor 504 cause the processor 504 to perform operations such as any of the operations and functions for which the computing system 500 is configured, as described herein. Additionally, or alternatively, the memory 506 may store data (not shown) that may be obtained, received, accessed, written, manipulated, created, and/or stored. The data may include, for instance, the data and/or information described herein in relation to FIGS. 1-4. In some implementations, the computing device 502 may obtain from and/or store data in one or more memory device(s) that are remote from the computing system 500.

The computing device 502 may further include an input/output (I/O) interface 514 communicatively coupled to the address bus 508, the control bus 510, and the data bus 512. The data bus 512 may include a plurality of tunnels that may support communication in the environment 100. The I/O interface 514 is configured to couple to one or more external devices (e.g., to receive and send data from/to one or more external devices). Such external devices, along with the various internal devices, may also be known as peripheral devices. The I/O interface 514 may include both electrical and physical connections for operably coupling the various peripheral devices to the computing device 502. The I/O interface 514 may be configured to communicate data, addresses, and control signals between the peripheral devices and the computing device 502. The I/O interface 514 may be configured to implement any standard interface, such as a small computer system interface (SCSI), a serial-attached SCSI (SAS), a fiber channel, a peripheral component interconnect (PCI), a PCI express (PCIe), a serial bus, a parallel bus, an advanced technology attachment (ATA), a serial ATA (SATA), a universal serial bus (USB), Thunderbolt, FireWire, various video buses, and the like. The I/O interface 514 is configured to implement only one interface or bus technology. Alternatively, the I/O interface 514 is configured to implement multiple interfaces or bus technologies. The I/O interface 514 may include one or more buffers for buffering transmissions between one or more external devices, internal devices, the computing device 502, or the processor 504. The I/O interface 514 may couple the computing device 502 to various input devices, including touch screens, scanners, biometric readers, electronic digitizers, receivers, touchpads, cameras, keyboards, any other pointing devices, or any combinations thereof. The I/O interface 514 may couple the computing device 502 to various output devices, including printers, projectors, tactile feedback devices, automation control, robotic components, actuators, transmitters, signal emitters, lights, and so forth.

The computing system 500 may further include a storage unit 516, a network interface 518, an input controller 520, and an output controller 522. The storage unit 516, the network interface 518, the input controller 520, and the output controller 522 are communicatively coupled to the central control unit (e.g., the memory 506, the address bus 508, the control bus 510, and the data bus 512) via the I/O interface 514. The network interface 518 communicatively couples the computing system 500 to one or more networks such as wide area networks (WAN), local area networks (LAN), intranets, the Internet, wireless access networks, wired networks, mobile networks, telephone networks, optical networks, or combinations thereof. The network interface 518 may facilitate communication with packet-switched networks or circuit-switched networks which use any topology and may use any communication protocol. Communication links within the network may involve various digital or analog communication media such as fiber optic cables, free-space optics, waveguides, electrical conductors, wireless links, antennas, radio-frequency communications, and so forth.

The storage unit 516 is a computer-readable medium, preferably a non-transitory computer-readable medium, comprising one or more programs, the one or more programs comprising instructions which when executed by the processor 504 cause the computing system 500 to perform the method steps of the present disclosure. Alternatively, the storage unit 516 is a transitory computer-readable medium. The storage unit 516 may include a hard disk, a floppy disk, a compact disc read-only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 516 stores one or more operating systems, application programs, program modules, data, or any other information. The storage unit 516 is part of the computing device 502. Alternatively, the storage unit 516 is part of one or more other computing machines that are in communication with the computing device 502, such as servers, database servers, cloud storage, network attached storage, and so forth.

The input controller 520 may include suitable logic, circuitry, interfaces, and/or code, executable by the circuitry, that may be configured to control one or more input devices that may be configured to receive a procedural SQL code block. The output controller 522 may include suitable logic, circuitry, interfaces, and/or code, executable by the circuitry, that may be configured to control one or more output devices that may be configured to render the application or the set of business rules on the user device 108.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems and methods of analysis of procedural SQL codes. While various embodiments of the disclosed systems and methods have been described above, they have been presented for purposes of example only, and not limitations. It is not exhaustive and does not limit the present disclosure to the precise form disclosed. Modifications and variations are possible considering the above teachings or may be acquired from practicing the present disclosure, without departing from the breadth or scope.

What is claimed is:

1. A system, comprising:
processing circuitry configured to:
parse a code block comprising a plurality of code elements, each code element corresponding to one of a code block name, a parameter, a variable, a statement, or a condition;
generate, based on the parsing of the code block, a parse tree that comprises a plurality of nodes for each code element of the plurality of code elements, with each node representing a token of the corresponding code element;
generate, in the parse tree, one or more directed edges defining dependency between the plurality of code elements such that each directed edge couples two nodes associated with two different code elements;
generate a context for at least one code element of the plurality of code elements, the context being indicative of a purpose of the at least one code element in the code block;
split, based on the parse tree with the one or more directed edges, the code block into a plurality of chunks, each chunk comprising at least one of (i) a subset of the code block and (ii) one or more contexts of one or more code elements, of the plurality of code elements, present in the corresponding subset of the code block, respectively; and
process the plurality of chunks to generate an output associated with the code block.

2. The system of claim 1, wherein the parse tree comprises a plurality of sub-trees that represent the plurality of code elements, and wherein each sub-tree, of the plurality of sub-trees, includes the corresponding plurality of nodes arranged in a hierarchical manner.

3. The system of claim 1, wherein the processing circuitry is further configured to pre-process the code block prior to the parsing of the code block.

4. The system of claim 3, wherein the code block further comprises a plurality of comments, and wherein the pre-processing of the code block results in removal of the plurality of comments from the code block.

5. The system of claim 1, wherein the code block corresponds to a procedural structured query language (SQL) code block.

6. The system of claim 1, wherein the output associated with the code block corresponds to a set of business rules associated with the code block.

7. The system of claim 6, wherein the processing circuitry is further configured to engineer an application based on the set of business rules associated with the code block, and wherein a codebase of the engineered application differs from a codebase of the code block.

8. The system of claim 1, wherein the processing circuitry generates the context for the at least one code element using a large language model.

9. The system of claim 8, wherein to generate the context for the parameter or the variable, the processing circuitry is further configured to process, using the large language model, a portion of the code block including the parameter or the variable.

10. The system of claim 8, wherein to generate the context for the condition, the processing circuitry is further configured to process, using the large language model, (i) a portion of the code block including the condition and (ii) the context generated for each parameter and variable present in the portion of the code block that includes the condition.

11. The system of claim 1, wherein to process each chunk of the plurality of chunks, the processing circuitry is further configured to:
generate a prompt for the corresponding chunk; and
generate, using a large language model, a response to the generated prompt, the response corresponding to a set of business rules associated with the corresponding chunk.

12. The system of claim 11, wherein the processing circuitry is further configured to generate, using the large language model, the output associated with the code block based on a plurality of responses generated for the plurality of chunks, and wherein the output associated with the code block corresponds to the set of business rules associated with the code block in entirety.

13. The system of claim 12, wherein the processing circuitry is further configured to split the plurality of responses based on a query size limit of the large language model prior to the generation of the output.

14. The system of claim 1, further comprising a storage element that is coupled to the processing circuitry,
wherein the storage element is configured to store a parameter table that includes a mapping between a set of parameters and a set of contexts of the set of parameters, and
wherein during the splitting of the code block, if at least one parameter, of the set of parameters, is present in the subset of the code block, the processing circuitry is further configured to access the parameter table to obtain a context, of the one or more contexts, mapped to the at least one parameter.

15. The system of claim 1, further comprising a storage element that is coupled to the processing circuitry,
wherein the storage element is configured to store a variable table that includes a mapping between a set of variables, a set of line numbers where the set of variables appear in the code block, and a set of contexts of the set of variables, and
wherein during the splitting of the code block, if at least one variable, of the set of variables, is present in the subset of the code block, the processing circuitry is further configured to determine a line number range of the subset of the code block, access the variable table to identify a line number that is less than and nearest to the line number range, and obtain a context, of the one or more contexts, mapped to the at least one variable and the identified line number.

16. The system of claim 15, wherein the variable table includes a same variable appearing in two different line numbers of the code block having two different contexts.

17. The system of claim 1, further comprising a storage element that is coupled to the processing circuitry,
wherein the storage element is configured to store a condition table that includes a mapping between a set of conditions and a set of contexts of the set of conditions, and
wherein during the splitting of the code block, if at least one condition, of the set of conditions, is present in the subset of the code block, the processing circuitry is further configured to access the condition table to obtain a context, of the one or more contexts, mapped to the at least one condition.

18. The system of claim 1, wherein to split the code block, the processing circuitry is further configured to execute a depth-first traversal of the parse tree with the one or more directed edges, the one or more directed edges being used for code element dependency analysis.

19. The system of claim 1, wherein a count of tokens in the subset of the code block included in each chunk of the plurality of chunks is within a chunk size limit, wherein the processing circuitry processes the plurality of chunks using a large language model, and wherein the chunk size limit is defined based on a query size limit of the large language model utilized for processing the plurality of chunks.

20. A method, comprising:
parsing, by processing circuitry, a code block comprising a plurality of code elements, each code element corresponding to one of a code block name, a parameter, a variable, a statement, or a condition;
generating, by the processing circuitry, based on the parsing of the code block, a parse tree that comprises a plurality of nodes for each code element of the plurality of code elements, with each node representing a token of the corresponding code element;
generating, by the processing circuitry, in the parse tree, one or more directed edges defining dependency between the plurality of code elements such that each directed edge couples two nodes associated with two different code elements;
generating, by the processing circuitry, a context for at least one code element of the plurality of code elements, the context being indicative of a purpose of the at least one code element in the code block;
splitting, by the processing circuitry, based on the parse tree with the one or more directed edges, the code block into a plurality of chunks, each chunk comprising at least one of (i) a subset of the code block and (ii) one or more contexts of one or more code elements, of the plurality of code elements, present in the corresponding subset of the code block, respectively; and
processing, by the processing circuitry, the plurality of chunks to generate an output associated with the code block.
